(19) United States
(12) Patent Application Publication
(10) Pub. No.: US 2015/0096278 A1
(43) Pub. Date: Apr. 9, 2015

(54) LAWNCARE IMPLEMENTS

(71) Applicant: S & B LAWN SYSTEMS, INC., BROOKFIELD, WI (US)

(72) Inventors: Steven A. Sprinkmann, Germantown, WI (US); Stefan Behling, Brookfield, WI (US); John Ward, Milwaukee, WI (US); Daniel Riley, Hartland, WI (US)

(21) Appl. No.: 14/507,478

(22) Filed: Oct. 6, 2014

Related U.S. Application Data
(60) Provisional application No. 61/887,155, filed on Oct. 4, 2013.

(51) Int. Cl. A01D 43/00; A01D 34/00

(52) U.S. Cl. CPC A01D 43/006; A01D 34/001
USPC 56/17.4; 172/170

(57) ABSTRACT

Provided are devices, systems and methods related to lawn implements for use in landscaping. Devices including lawn implements such as rollers, stripers, dethatchers, aerators, and lawn spreaders adapted to be selectively coupled to a walk-behind lawn implement, such as a walk-behind lawn mower. A receiver system is provided to be coupled to or as a part of the walk-behind lawn implement. In use, the devices coupled to the walk-behind lawn implement are preferably disposed beneath the handle of the implement.

### RELATED APPLICATIONS

This application claims the benefit of co-pending U.S. Provisional Patent Application No. 61/887,155, filed 4 Oct. 2013, and entitled “Lawncare Implements,” which is incorporated herein by reference in its entirety.

### BACKGROUND OF THE INVENTION

The present invention relates generally to lawn care implements, and more specifically to implements that may be interfaced with or a part of walk-behind lawn apparatus, such as walk-behind mowers.

Lawn implements have been utilized for decades for the grooming and maintenance of residential and commercial landscapes. Implements may include reel mowers, motorized manual push mowers, motorized selectively self-propelled walk-behind mowers, walk-behind spreaders, aerators, and sweepers.

While the coupling and de-coupling of accessories, especially ground-supported accessories, has heretofore been performed with motorized, operator-supporting apparatus, accessory coupling to operator-grounded, manually commanded apparatus has been limited.

### SUMMARY OF THE INVENTION

Embodiments according to the present invention include devices, systems, and methods related to accessories and the coupling of such accessories to operator-grounded, manually commanded lawn implements.

According to a first embodiment of an apparatus according to the present invention, a roller apparatus for striping lawns is provided, the roller apparatus including a cover, a rolling drum and a mount is provided. The rolling drum is rotatably supported by an axle through the rolling drum and the cover. The mount, which may include a V-shaped member secured to the cover, is configured to secure the roller apparatus to a lawn mower, preferably a manual push mower. The mount may further include a mounting bracket affixed to the apex of the V-shaped member. A brush implement, secured forward the rolling drum, includes a plurality of bristles arranged substantially perpendicular to the ground.

A second embodiment of an apparatus according to the present invention includes a mower deck, and a handle coupled to the mower deck, adapted to be grasped by a human hand to guide the mower deck over a ground surface. A blade may be positioned below and shrouded by the mower deck and a motor may be positioned above the mower deck and coupled through a shaft to the blade, operative to rotate the blade in a first plane. A cylindrical roller may be coupled to and positioned outside of the mower deck, the roller having an axis of rotation disposed substantially perpendicular to the shaft. A plurality of tines may be coupled to and positioned outside of the mower deck, the tines being disposed substantially perpendicular to the first plane and located between the roller and the mower deck.

According to an aspect of an embodiment of an apparatus according to the present invention, the tines and the roller may be located between the mower deck and a plane extending from a free end of the handle and parallel to the shaft.

A method according to the present invention includes a method of imparting a semi-permanent bend to blades of grass. The method includes the steps of coupling a roller apparatus including tines and a cylindrical roller to a manual push mower having a handle and manually pushing the handle to guide the mower and the roller apparatus along a ground surface having grass extending upward therefrom. The force of the roller apparatus upon the grass imparts a semi-permanent bend to blades of the grass.

According to an aspect of a method according to the present invention, the tines may project below the upper height of blades of grass cut by the mower but preferably do not contact the ground surface, so as to comb the blades of grass in a forward direction in preparation for the roller to impart the bend thereto.

### BRIEF DESCRIPTION OF THE DRAWINGS

FIG. 1 is a right side elevation of an embodiment of a lawn implement according to the present invention.

FIG. 2 is a top perspective partially exploded view of the lawn implement of FIG. 1, further including a mounting system.

FIG. 3 is a rear elevation view of the assembled embodiment of FIG. 2.

FIG. 4 is a top perspective view of an embodiment of a lawn implement mounting system according to the present invention.

FIG. 5 is a top plan view of an embodiment of an implement mount according to the present invention.

FIG. 6 is a top plan view of an embodiment of a mounting bracket according to the present invention.

FIG. 7 is a top plan view of an embodiment of a mounting member according to the present invention.

FIG. 8a is a top plan view of an embodiment of an end cap according to the present invention.

FIG. 8b is a rear elevation view of the embodiment of FIG. 8a.

FIG. 8c is a rear-top-right perspective view of the embodiment of FIG. 8a.

FIG. 9 is a top plan view of an embodiment of a central roller shroud according to the present invention.

FIG. 10a is a perspective view of a first embodiment of a mounting receiver bracket according to the present invention.

FIG. 10b is a perspective view of a second embodiment of a mounting receiver bracket according to the present invention.

FIG. 11 is a top plan view of an embodiment of a mounting frame according to the present invention.

FIG. 12 is a right elevation view of an implement, system and method according to the present invention.

FIG. 13 is a partial rear elevation view an embodiment of a mower-mounted receiver mechanism according to the present invention.

FIG. 13A is a magnified, partially rotated perspective view of a portion of FIG. 13.

FIG. 14A is a cross-section view of a portion of FIG. 1.

FIG. 14B is an embodiment of a coupling arrangement according to the present invention.

FIG. 15 is a perspective view of the coupling arrangement of FIG. 14B.

FIG. 16A is an alternate embodiment of an implement according to the present invention including a dethatching, or rake, apparatus.

FIG. 16B is an alternate embodiment of an implement according to the present invention including a lawn aerator.

FIG. 16C is an alternate embodiment of an implement according to the present invention including a lawn spreader.

FIG. 17 is a perspective view of an alternate embodiment of the lawn implement of FIG. 1.

FIG. 18 is a perspective view of a comb used in the embodiment of FIG. 17.

FIG. 19 is a cross-sectional view taken along line 19-19 of FIG. 17.

FIG. 20 is an end view taken at line 20 of FIG. 18.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

This invention relates to a lawn roller for striping lawns and more particularly to such a device having a brush implement configured to comb and align blades of grass before the roller passes over the blades, and to a mounting system for such device. The aligned blades allow for greater reflection and absorption of light, creating a more vibrant striping effect.

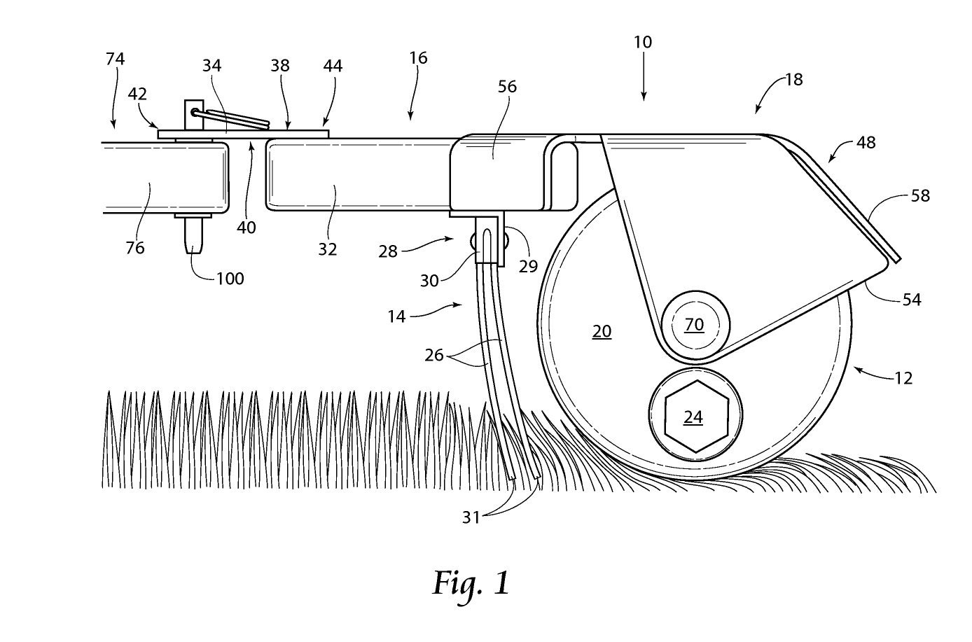

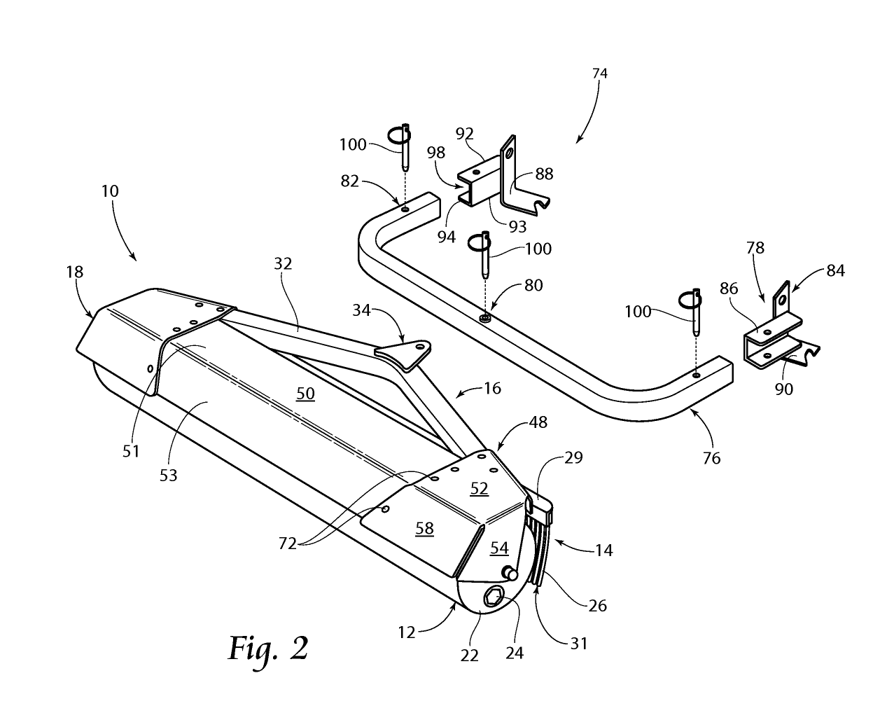

FIG. 1 generally illustrates a side view of a roller apparatus 10. FIG. 2 generally illustrates a top perspective view of the roller apparatus 10. As seen in FIGS. 1-2 the roller apparatus 10 includes a rolling drum 12, a brush implement 14, a mount 16, and a cover 18.

As seen in FIGS. 1-2, the rolling drum 12 is generally cylindrical in shape and includes a left edge 20 and a right edge 22. The rolling drum 12 may be hollow-cored and include a plug 24 which may be removed to allow the rolling drum 12 to be filled with any suitable substance, such as water or sand, to give the rolling drum 12 sufficient mass to impart a bend on blades of grass. It is understood, however, that the rolling drum 12 may be either hollow-cored or solid-cored and may be constructed of any suitable material to allow the drum to impart a semi-permanent bend to the blades of grass.

The brush implement 14 includes a plurality of bristles 26 and a securement mechanism 28 for securing one end of each of the bristles 26 to the roller apparatus 10. The securement mechanism 28 includes an L-shaped bar 29 and a bristle securement device 30. Each bristle 26 is generally elongate and includes one free end 31. The end of each bristle 26 that is opposite the free end 31 is secured by the bristle securement device 30 such that each bristle is generally perpendicular to the ground. In addition, the L-shaped bar 29 is secured to the roller apparatus 10 forward of the rolling drum 12 such that the securement mechanism 28 is arranged generally parallel to the rolling drum 12. It is to be understood, however, that the securement mechanism 28 may take whatever form desired; for example, the L-shaped bar 29 may instead be U-shaped and hold the bristle securement device between the arms of the bar.

Referring specifically to FIG. 1, the bristles 26 may be of any suitable length such that the free end 31 of each bristle 26 extends below the uppermost height of the blades of grass but does not come into contact with the ground. The bristles 26 may be constructed of any suitably rugged material, such as polypropylene or nylon, to ensure the effectiveness of combing while minimizing any harm that may come to the grass due to an inflexible bristle passing through it. The brush implement 14 is secured within the roller apparatus 10 forward of the rolling drum 12 such that the bristles 26 pass through the grass before the rolling drum 12 passes over and imparts a bend to the grass.

As seen in FIGS. 1-3 and 5-7, the mount 16 includes a V-shaped member 32 and a mounting bracket 34. Referring specifically to FIG. 7, the V-shaped member 32 has a generally square cross-section; it is understood, however, that the V-shaped member 32 may take whatever cross-sectional shape is desired. The V-shaped member 32 includes a plurality of openings 36 on each leg portion of the V-shaped member 32. The openings 36 located on each leg portion are arranged generally parallel to the edges of the V-shaped member 32 and near each distal end of the V-shaped member 32.

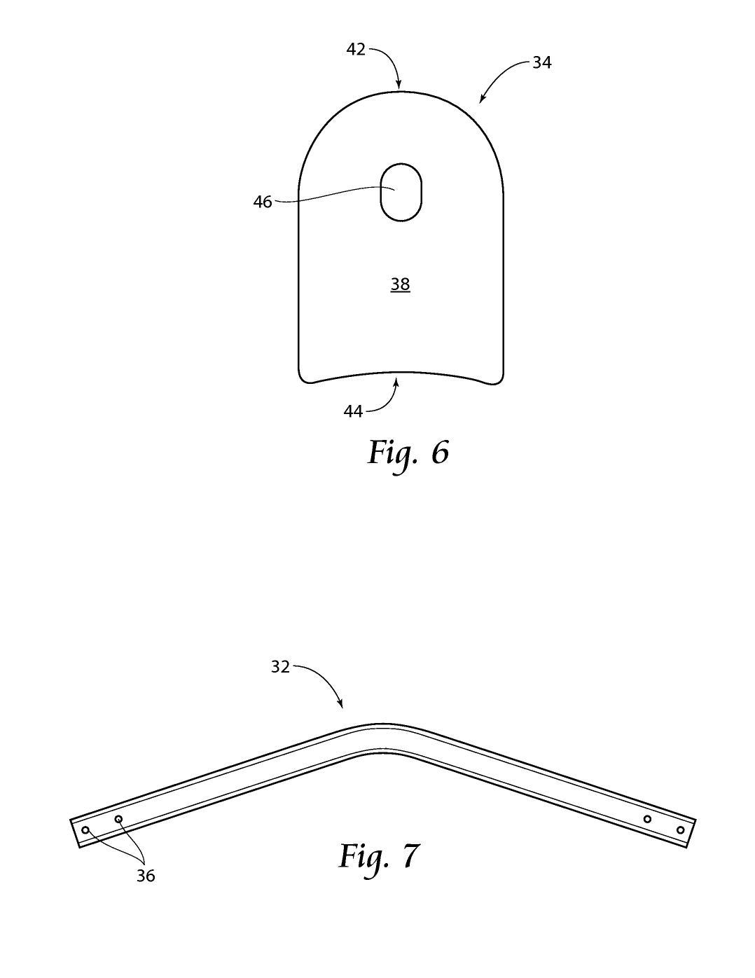

Referring now to FIGS. 1 and 6, the mounting bracket 34 includes an upper surface 38, a lower surface 40, a front end 42 and a back end 44. In addition, the mounting bracket 34 includes an opening 46 that extends between the upper surface 38 and the lower surface 40 near the front end 42 of the mounting bracket 34.

Referring now to FIGS. 1 and 5, the lower surface 40 of the mounting bracket 34 is fixedly attached to the V-shaped member 32 near the apex of the V-shaped member 32 and near the back end 44 of the mounting bracket 34.

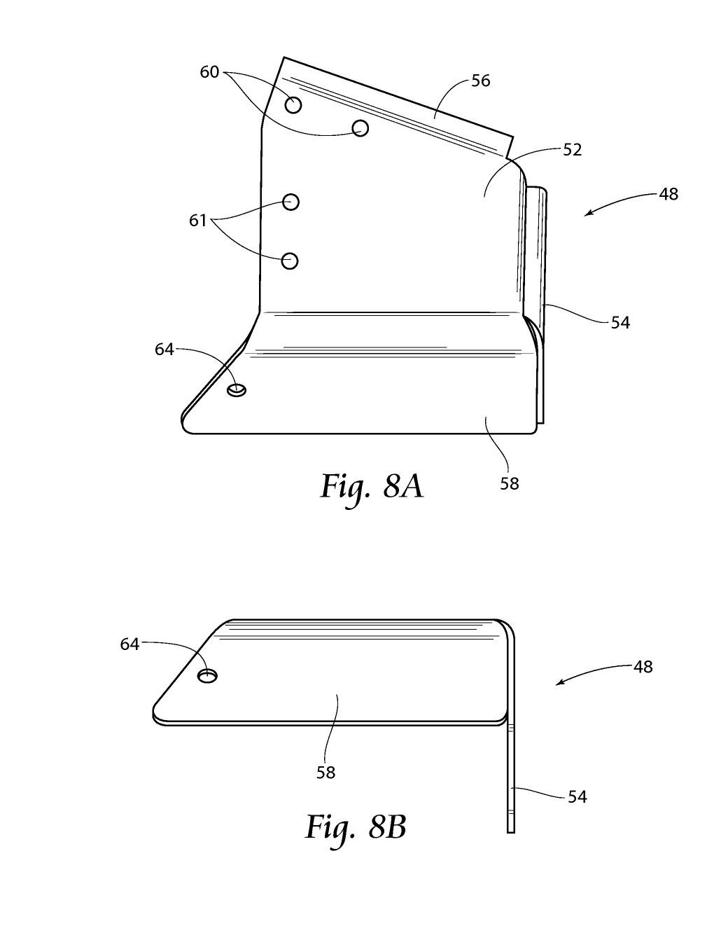

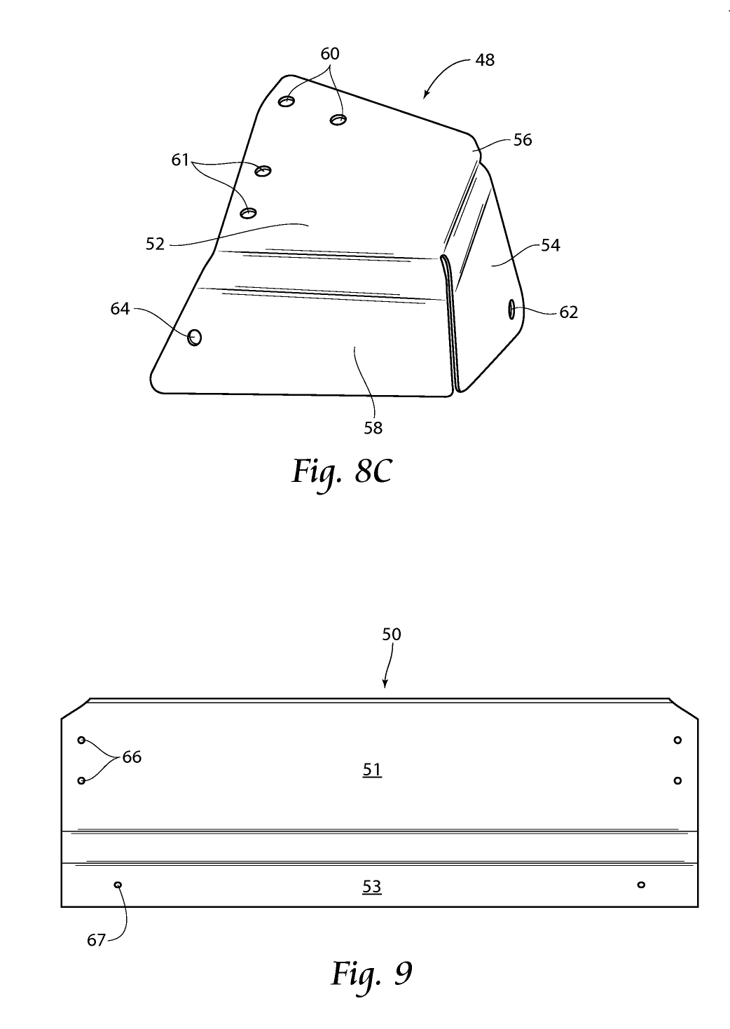

As seen in FIGS. 1-3 and 8-9, the cover 18 of the roller apparatus 10 includes end caps 48 and a central shroud portion 50. Referring now to FIGS. 8a-c, wherein FIG. 8a is a top view of the end cap 48, FIG. 8b is a rear view of the end cap 48, and FIG. 8c is a perspective view of the end cap 48, each end cap 48 includes a top portion 52, a side portion 54, a front portion 56, and a back portion 58. The top portion 52 of the end cap 48 includes a plurality of openings 60 therethrough. In addition, the side portion 54 of the end cap 48 includes an opening 62 therethrough, and the back portion 58 of the end cap 48 includes an opening 64 therethrough.

Referring specifically to FIG. 9, the central shroud portion 50 of the cover 18 includes a top area 51 and a rear area 53. The top area 51 of the central shroud portion 50 includes a plurality of openings 66 that extend through the top area 51. A plurality of fasteners 72 extend through the plurality of openings 66 through the central portion 50 and the plurality of openings 61 through the end caps 48 to join the end caps 48 to the central shroud portion 50. In addition, the rear area includes openings 67 that extend through the rear area 53 of the central shroud portion 50 and through which fasteners 72 serve to further join the end caps 48 to the central shroud portion 50.

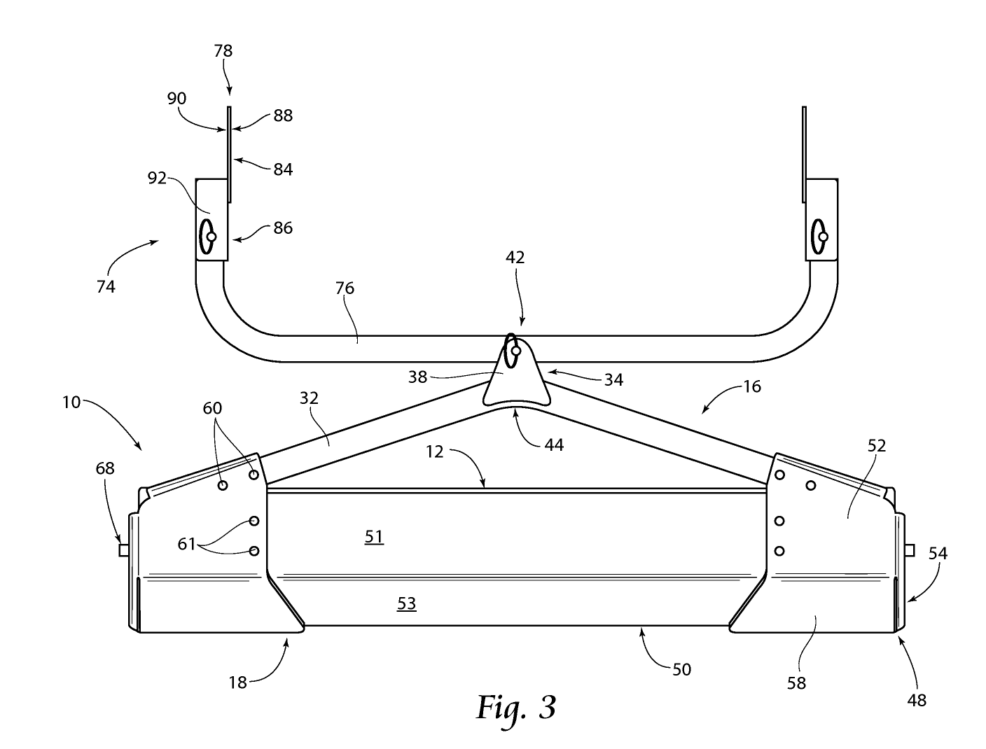

Referring now to FIGS. 3, an axle 68 extends through the openings 62 in the side portion 54 of the end caps 48 and through the rolling drum 12. The axle 68 secures the rolling drum 12 to the end caps 48, and the rolling drum 12 rotates freely about the axle 68 when the rolling apparatus 10 is in use. Referring specifically to FIG. 1, each end of the axle 68 is covered by an end cap 70 to prevent the axle 68 from sliding out of position while the rolling apparatus 10 is in use.

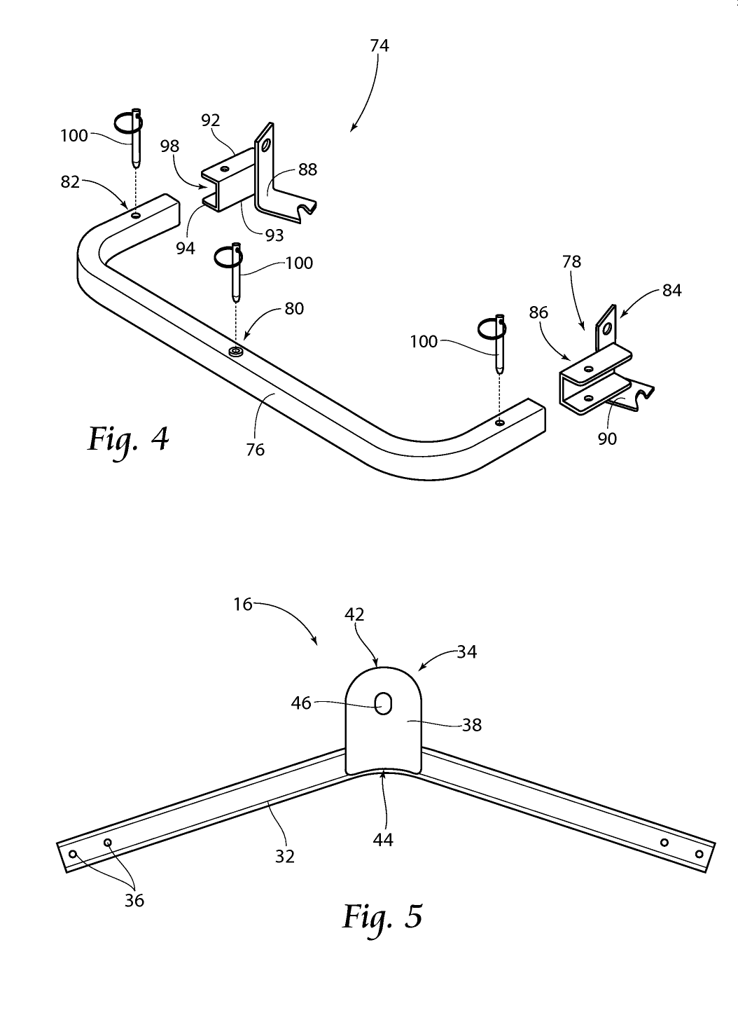

The V-shaped member 32 is also secured to the end caps 32 via fasteners 72. The fasteners 72 extend through the plurality of openings 60 in the top portion 52 of the end cap 48 and through the openings 36 arranged along lines B-B and C-C through the V-shaped member 32. Referring now to FIGS. 2-4 and 10-11, a bracketing system 74 includes a U-shaped frame 76 and brackets 78. Referring specifically to FIGS. 4 and 11, the U-shaped frame 76 has a generally square cross-section; it is to be understood, however, that the frame may have a cross-section in any shape so desired. In addition, the U-shaped frame 76 includes an opening 80 extending through the U-shaped frame 76 and near the midpoint of the U-shaped frame 76. The U-shaped frame 76 also includes openings 82 near the distal ends of the leg portions of the U-shaped frame 76.

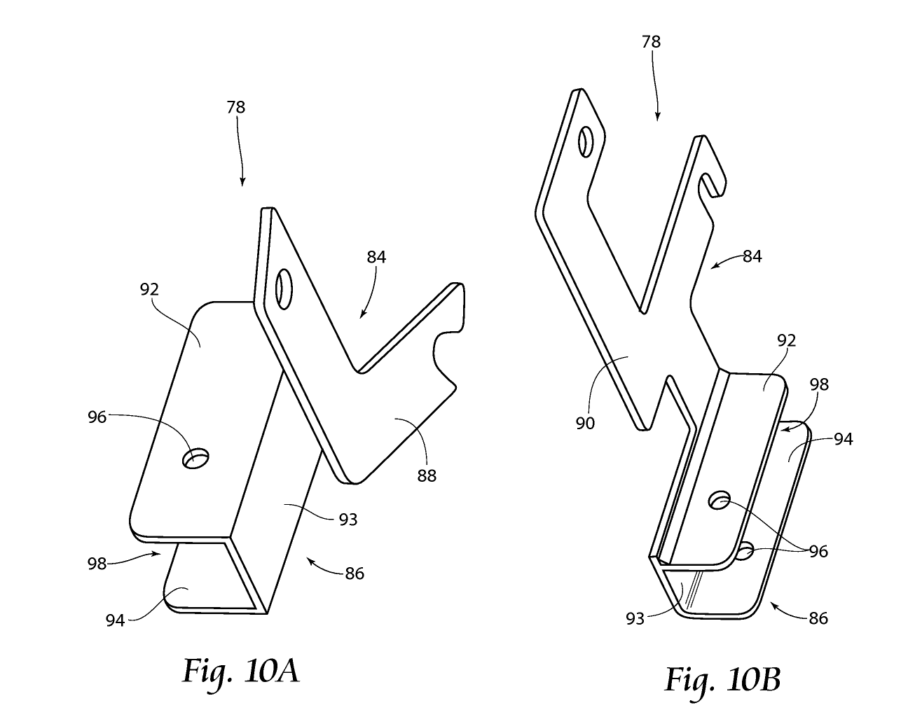

Referring specifically to FIGS. 10a and 10b, the brackets 78 include an interior portion 84 and a C-shaped member 86. The interior portion 84 includes an inner surface 88 and an outer surface 90. The inner surface 88 of the interior portion 84 is configured to be removably attached to a suitable walk behind lawn mower. As seen in the alternate embodiments shown in FIGS. 10a and 10b, the interior portion 84 of the brackets 78 may take a variety of forms to allow for attachment to different models of walk behind mowers. The outer surface 90 of the interior portion 84 is fixedly attached to the C-shaped member 86.

The C-shaped member 86 of the bracket 78 includes an upper arm 92, a middle portion 93, and a lower arm 94. In addition, an aligned opening 96 extends between and through the upper arm 92 and the lower arm 94. The upper arm 92 and the lower arm 94 of the C-shaped member 86 define a gap 98 into which the distal ends of the leg portions of the U-shaped frame 76 are inserted. When the openings 82 through the U-shaped frame 76 are aligned with the openings 96 through the C-shaped member 86 a pin 100 is inserted through the openings 82, 96 and secures the U-shaped frame 76 to the brackets 78. It is to be understood, however, that the C-shaped member 86 may take whatever shape necessary to receive and hold the distal ends of the U-shaped frame 76.

Referring now to FIGS. 1 and 2, the mounting bracket 34 secures the roller assembly 10 to the bracketing system 74 via a pin 100 that extends through the opening 46 in the mounting bracket 34 and through the opening 80 in the U-shaped frame 76. In addition, the bracketing system 74 allows an attachment, such as the roller apparatus 10, to be used on a suitable walk behind lawn mower with or without a bagging system attached to the mower.

Referring now to FIG. 1, when a lawn mower moves in a forward direction, the lawn mower pulls the roller apparatus 10 along the same path that the lawn mower travels. After the lawn mower passes over and cuts the blades of grass, the bristles 26 pass through the grass and detangle and align the blades of grass. The aligned blades of grass are then bent by the rolling drum 12 passing over the blades of grass. When the blades of grass are aligned by the bristles 26 before the rolling drum 12 passes over the blades of grass, the resulting striping effect is enhanced as the prealigned blades of grass allow for optimum light reflection; in addition, aligning the blades of grass before the roller passes over them allows the rolling apparatus 10 to smooth out the harsh edges left behind by mower wheels. Overall, the combing action aligning and orienting the blades of grass, before the roller passes over the blades of grass, creates a more vibrant striping effect.

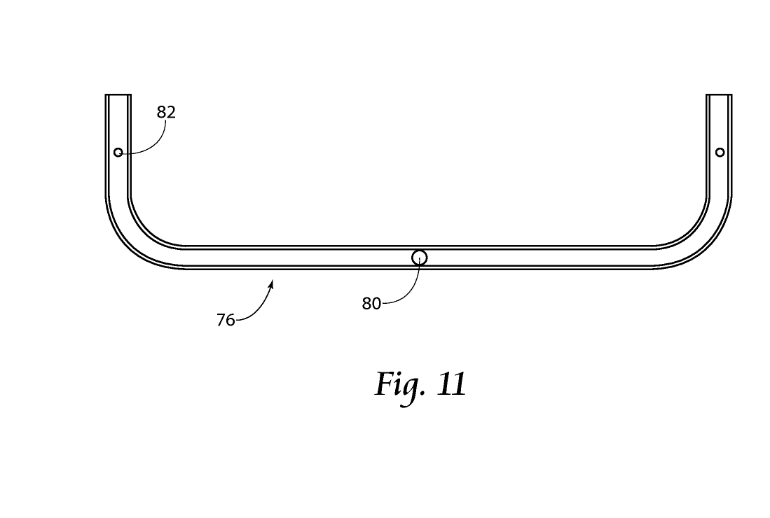

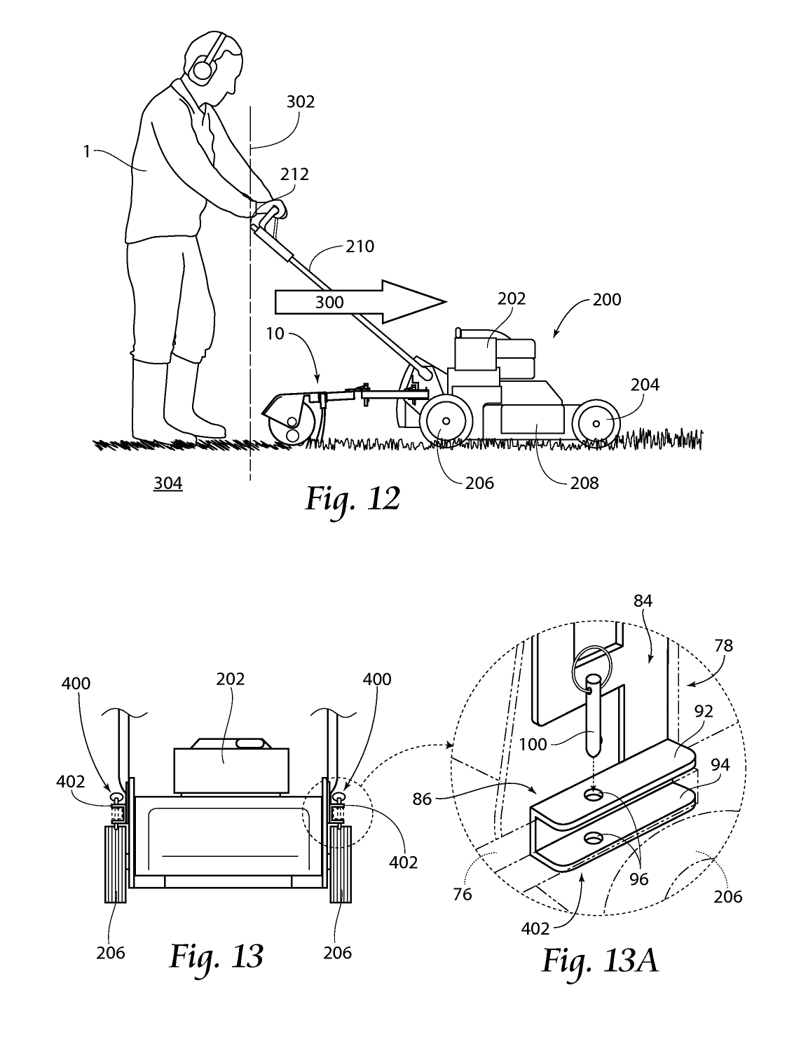

Turning now to FIG. 12, an implement 10 according to the present invention is shown coupled to a walk-behind lawn mower 200. Generally, the mower 200 is commanded in a forward direction 300 by a person 1. The mower 200 may be self-propelled, meaning that the motor 202 may supply power to the front wheels 204 and/or rear wheels 206 of the mower 200. The mower 200 also has a mowing deck 208 and a handle 210. The mowing deck 208 operates as the main structural component of the mower 200, ultimately supporting the motor 202 and the handle 210. The handle 210 has a free end 212, generally disposed in a rear plane 302 disposed perpendicular to the ground 304 or a plane formed by a tangent of the front wheels 204 and rear wheels 206 of the mower 200. In use, the implement 10 is preferably disposed between the user 1 and the mowing deck 208, and under the handle 210. More preferably, in use, the implement 10 is further forward 300 than the rear plane 302.

With reference to FIGS. 13 and 13A, a walk-behind mower receiver system 400 may be described. The receiver system 400 may be comprised by one or more mounting brackets, such as brackets 78 described above, mounted to the mower 200. The brackets 78 may be provided with or without the interior portion 84, but include at least a receiver portion 402, adapted to receive a portion of the implement 10 or mounting frame, such as the U-shaped frame 76. The receiver portion 402 preferably includes a male or female mounting structure. A male mounting structure (not shown), may include an extruded peg, shaft, or other member adapted to be inserted into a portion of the implement 10 or mounting frame. A female mounting structure may be an open or closed channel, such as the C-shaped member 86, adapted to accept a portion of the implement 10 or mounting frame. The receiver portion 402 may be removably coupled (e.g., removable with hand tools without destruction) to the mower 200 or permanently coupled thereto (e.g., as by welding).

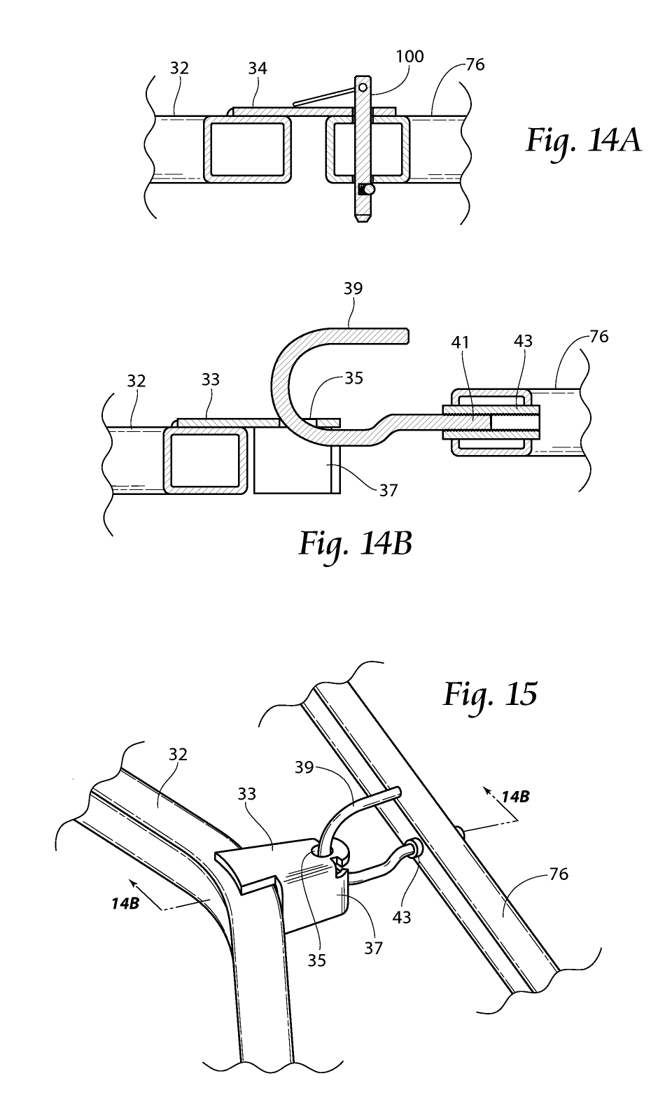

FIG. 14A is a cross-section view showing the coupling of the V-shaped member 32 and the U-shaped member 76 of FIG. 1. FIGS. 14B and 15 depict an alternative coupling of the V-shaped member 32 and the U-shaped member 76 according to the present invention. An alternative mounting bracket 33 is provided in the nature of a mounting plate, similar to the mounting bracket 34 previously described. The mounting bracket 33 further preferably includes a coupling aperture 35 and one or more bumpers 37. The bracket 33 is preferably formed out of a unitary piece of material, and is secured to the V-shaped member 32, such as by welding or other secure fastening means. A hook member 39 is provided and secured to the U-shaped member 76. The hook member 39 is preferably a cylindrical rod of a predetermined diameter, such as about 0.25 inches, which may be threaded on a shank end 41. Disposed through a horizontal aperture formed through the U-shaped member 76 is a threaded bushing 43, into which the shank end 41 of the hook member 39 may be inserted and supported. To use the alternative coupling arrangement, the hook 39 is simply passed through the aperture 35 in the mounting bracket 33, which imparts maneuverability to the bracket 33, and thus the V-shaped member 32 and any attached implement, in a plurality of planes, up and down, left and right.

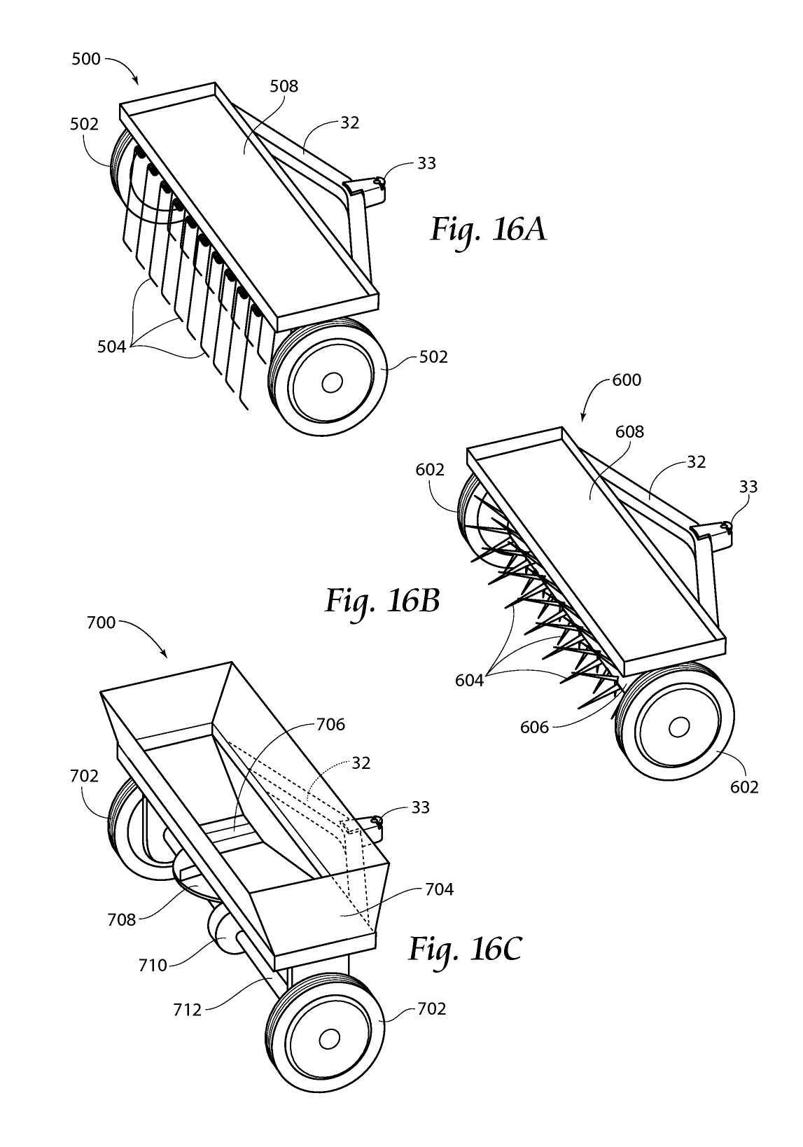

FIG. 16A shows an alternative embodiment 500 of an implement according to the present invention, in the form of a dethatcher, or rake. The implement 500 is supported upon a travel surface (e.g. a lawn) by two wheels 502, which may be joined by a single axle. Extending downward between the wheels 502 is a plurality of tines 504, which may be spring-biased. The tines 504 may all be of uniform length, or varying lengths. Also provided may be a ballast tray 508, adapted to receive materials to weight down the implement 500 during use. Such materials may include sand bags, concrete blocks, bricks, logs, etc. Much like the roller 10 previously described, the dethatching implement 500 includes a V-shaped member 32 and a mounting bracket 33 to couple to the U-shaped member 76 previously described. Also as with the roller implement 10, during use, the entire implement 500 is preferably disposed forward 300 of the rear plane 302 (from FIG. 12), so as to not greatly interfere with the walking pattern of the user.

Provided in FIG. 16B is an alternate embodiment 600 of an implement according to the present invention in the form of a lawn aerator. The implement 600 is supported upon a travel surface (e.g. a lawn) by two wheels 602. The aerator 600 includes a plurality of spikes 604, which may be supported upon an axle 606 which may also support the wheels 602. The spikes 604 extend a radial length away from the axle 606 that is greater than the radius of the wheels 602, such that when the implement 600 travels across a lawn, the spikes 604 pierce the soil of the lawn, so as to create punctures therein. Also provided may be a ballast tray 608, adapted to receive materials to weight down the implement 600 during use. Such materials may include sand bags, concrete blocks, bricks, logs, etc. Much like the roller 10 previously described, the dethatching implement 600 includes a V-shaped member 32 and a mounting bracket 33 to couple to the U-shaped member 76 previously described. Also as with the roller implement 10, during use, the entire implement 600 is preferably disposed forward 300 of the rear plane 302 (from FIG. 12), so as to not greatly interfere with the walking pattern of the user.

FIG. 16C provide an alternative embodiment 700 of an implement according to the present invention in the form of a lawn spreader. The implement 600 is supported upon a travel surface (e.g. a lawn) by two wheels 602. Supported substantially above the wheels 602 is a hopper 704 including a selectively openable chute 706. Materials such as fertilizer, seed, or other granulated and/or spreadable materials are placed in the hopper 704, and are delivered through the chute 706, when open, to a disk dispenser 708. The disk dispenser 708 rotates to broadcast the materials received from the hopper 704 through the chute 706. The disk 708 is preferably rotated by forces transferred through a basic gearbox 710, which may interface with an axle 712 that supports and rotates as the wheels travel upon the travel surface. Much like the roller 10 previously described, the dethatching implement 700 includes a V-shaped member 32 and a mounting bracket 33 to couple to the U-shaped member 76 previously described. Also as with the roller implement 10, during use, the entire implement 700 is preferably disposed forward 300 of the rear plane 302 (from FIG. 12), so as to not greatly interfere with the walking pattern of the user.

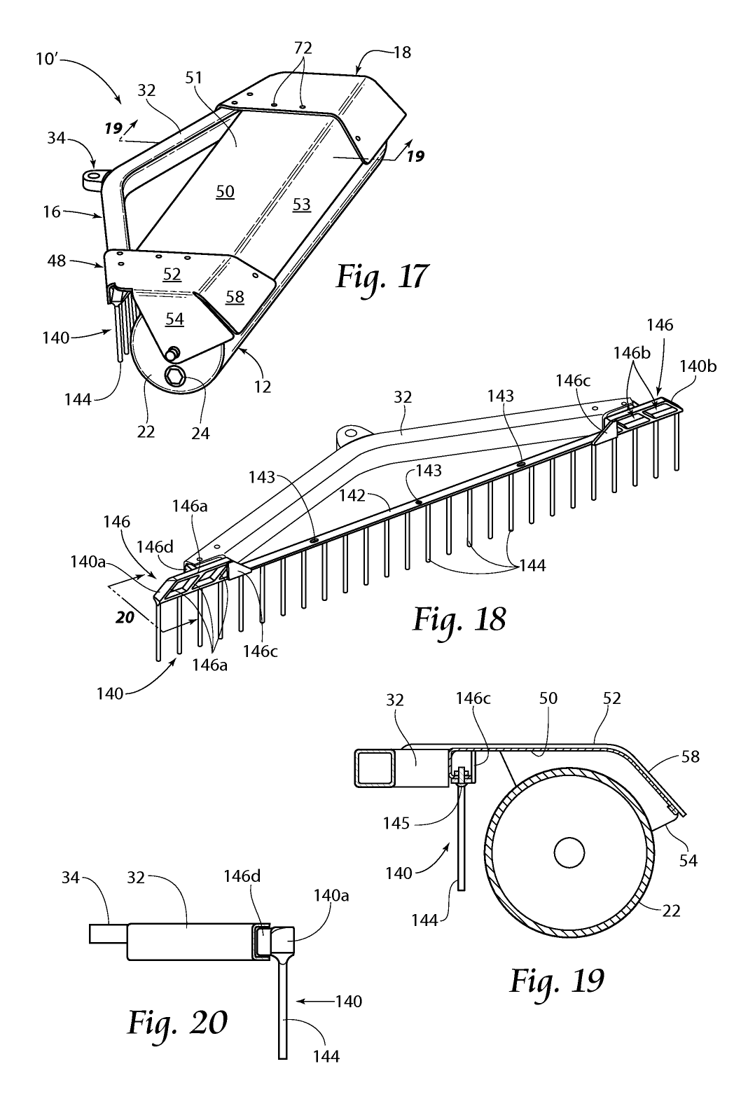

Turning now to FIGS. 17-20, an alternative embodiment 10′ of a lawn implement may be described, wherein similar reference numerals refer to similar or identical structure as previously discussed embodiments.

This embodiment 10′ includes a preferably unitary comb 140. The comb 140 includes a mounting plate 142 that extends at least partially along, but preferably completely through, a longitudinal length from a first end 140a to a second end 140b. Depending from a first surface of the plate 142 is a plurality of tines 144, which are preferably disposed in a parallel relationship with each other, and preferably all other, tines 144. Extending medially from each end 140a,140b is a comb reinforcement structure 146, which may include one or more reinforcement ribs 146a, which may surround one or more reinforcement cavities 146b. These cavities 146b may be provided to lighten the comb 140, or to enhance manufacturability, such as to maintain substantially uniform thickness of comb material during forming. Reinforcement gussets 146c may be used to reinforce a connection point between a most medial rib 146a and the mounting plate 142. A tube cap tab 146d may be provided as extending from a front surface of the comb 140, which may be aligned to substantially cover a portion of an otherwise open end of the V-shaped member 32.

The comb 140 is preferably a unitary member that is injection molded from a desirable material. While many materials were contemplated, desirable characteristics such as flexibility and strength were considered. Whatever material is used, such material preferably includes a flexural modulus of about 1.5 to about 2.3 gigapascals (e.g. about 265,000 psi) and a flexural strength of about 65 to about 75 megapascals (e.g. about 10200 psi), where such flexural characteristics may be tested according to an accepted standard, such as the ASTM D790 standard. A more preferred material may be heat and UV stabilized. One material from which the comb 140 may be formed is a nylon 6-6 (or polyamide 66) material, sold under the brand name of Hylon® N1000STHLUV2 HF, offered by Ravago Manufacturing Americas, LLC, headquartered out of Orlando, Fla.

To use the comb 140, it can be coupled to and supported by the central shroud portion 50 by one or more fastening members 145, such as bolts, inserted through apertures 143 formed through the mounting plate 142 and into the shroud portion 50, such as through a leg of a C-shaped front edge portion. Thus, the tines 144 may be supported substantially perpendicular to the top area 51 of the central shroud portion 50. When assembled, the each tine 144 preferably extends along a length that is longer than the radius of the cylindrical rolling drum 12.

A method of using an embodiment of a lawn implement according to the present invention includes the step of coupling a lawn implement to what is generally accepted as a manual push mower. The mower may include a motor to drive a rotating blade. The coupling step may include the provision of one or more brackets to be secured to the mower. The coupling step may also include the provision of a bridge member (e.g., the U-shaped frame 76) and the manual (e.g., without tools) coupling of the frame 76 to the bracket(s), and the coupling of the lawn implement to the frame 76. Once an implement is secured to the mower, the mower can be manually pushed and the implement employed. A method according to the present invention may alternatively or additionally include the step of decoupling a lawn implement from brackets secured to a push mower, preferably manually (e.g., without tools) and preferably while the brackets remain secured to the mower.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A roller apparatus for striping lawns, the roller apparatus comprising:
a cover;
a rolling drum rotatably supported by an axle through the rolling drum and the cover;
a mount configured to secure the roller apparatus to a lawn mower; and
a brush implement including a plurality of bristles arranged substantially perpendicular to the ground,
wherein the brush implement is secured to the roller apparatus forward of the rolling drum.

2. The roller apparatus of claim 1, wherein the mount comprises a V-shaped member secured to the cover.

3. An apparatus according to claim 2, wherein the mount further comprises a mounting bracket affixed to the apex of the V-shaped member.

4. An apparatus comprising:
a mower deck;
a handle coupled to the mower deck, adapted to be grasped by a human hand to guide the mower deck over a ground surface;
a blade positioned below and shrouded by the mower deck;
a motor positioned above the mower deck and coupled through a shaft to the blade, operative to rotate the blade in a first plane;
a cylindrical roller coupled to and positioned outside of the mower deck, the roller having an axis of rotation disposed substantially perpendicular to the shaft; and
a plurality of tines coupled to and positioned outside of the mower deck, the tines being disposed substantially perpendicular to the first plane and located between the roller and the mower deck.

5. An apparatus according to claim 4, wherein the tines and the roller are located between the mower deck and a plane extending from a free end of the handle and parallel to the shaft.

6. A method of imparting a semi-permanent bend to blades of grass, the method comprising the steps of:
coupling a roller apparatus including tines and a cylindrical roller to a manual push mower having a handle;
manually pushing the handle to guide the mower and the roller apparatus along a ground surface having grass extending upward therefrom,
wherein the force of the roller apparatus upon the grass imparts a semi-permanent bend to blades of the grass.

7. A method according to claim 6, wherein the tines project below the upper height of blades of grass cut by the mower but do not contact the ground surface.
